(19) United States
(12) Patent Application Publication
(10) Pub. No.: US 2016/0153865 A1
(43) Pub. Date: Jun. 2, 2016

(54) GAS TURBINE ENGINE AIRFOIL GROWTH INSPECTION METHOD

(71) Applicant: United Technologies Corporation, Hartford, CT (US)

(72) Inventors: Kyle C. Lana, Portland, CT (US); Stephen D. Haddock, Coventry, CT (US)

(21) Appl. No.: 14/812,723

(22) Filed: Jul. 29, 2015

Related U.S. Application Data
(60) Provisional application No. 62/036,341, filed on Aug. 12, 2014.

(51) Int. Cl. G01M 15/14; G01B 11/00; F01D 5/18

(52) U.S. Cl. CPC G01M 15/14; F01D 5/187; G01B 11/00

(57) ABSTRACT

A method of measuring untwist in an gas turbine engine airfoil, the method includes measuring first and second cooling holes on an exterior airfoil surface of an airfoil, determining untwist in a chord-wise direction and/or creep in a radial direction based upon the measurement, evaluating the determination relative to reference information for the airfoil, and outputting a part status based upon the evaluation.

### CROSS-REFERENCE TO RELATED APPLICATIONS

This application claims priority to U.S. Provisional Application No. 62/036,341 which was filed on Aug. 12, 2014 and is incorporated herein by reference.

This disclosure relates to an inspection method of a gas turbine engine airfoil. The inspection method includes determining creep of airfoil in a radial direction and/or untwist in a chord-wise direction.

### BACKGROUND

A gas turbine engine typically includes a fan section, a compressor section, a combustor section and a turbine section. Air entering the compressor section is compressed and delivered into the combustor section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

Temperatures within the turbine section are quite high. Accordingly, cooling holes have been typically used to cool the airfoil and create a boundary layer of cooling fluid about the exterior of the airfoil. Additionally, thermal barrier coatings have been applied to the airfoil to protect the blade from heat.

Regardless of the use of cooling fluid and protective coatings, the blade may creep or grow over time due to the high temperatures and loading of the airfoil during engine operation. To this end, creep in a radial direction has been measured during an engine overhaul to determine whether the blade is still within desired specifications. If the blade has grown beyond acceptable limits, it must be discarded and replaced.

### SUMMARY

In one exemplary embodiment, a method of measuring untwist in an gas turbine engine airfoil, the method includes measuring first and second cooling holes on an exterior airfoil surface of an airfoil, determining untwist in a chord-wise direction of the airfoil based upon the measurement, evaluating the determination relative to reference information for the airfoil and outputting a part status based upon the evaluation.

In a further embodiment of the above, the first cooling hole is near a leading edge of the airfoil. A second cooling hole is near a trailing edge of the airfoil.

In a further embodiment of any of the above, the first and second cooling holes are provided on a pressure side of the airfoil.

In a further embodiment of any of the above, the method includes the step of clamping the airfoil in a fixture. The measuring step is performed with the airfoil in the fixture.

In a further embodiment of any of the above, the measuring step is performed by optically measuring the first and second cooling holes.

In a further embodiment of any of the above, the measuring step includes determining a untwist focal distance to the first and second cooling holes. The reference information includes a reference focal distance of a new part.

In a further embodiment of any of the above, the determining step includes calculating a line in the chord-wised direction between the first and second cooling holes.

In a further embodiment of any of the above, the outputting step includes displaying a message as to whether the part is within desired specifications that correspond to the reference information.

In a further embodiment of any of the above, the determining step includes calculating a reference point within the measured cooling hole based upon a perimeter of the cooling hole.

In another exemplary embodiment, a method of measuring creep in an gas turbine engine airfoil, the method includes measuring first and second cooling holes near a trailing edge of an exterior airfoil surface, determining creep based upon the measurement, evaluating the determination relative to reference information for the airfoil, and outputting a part status based upon the evaluation.

In a further embodiment of the above, the determining step includes determining creep in a radial direction of the airfoil.

In a further embodiment of any of the above, the first and second cooling holes are arranged in a row.

In a further embodiment of any of the above, the row is an aft-most row of cooling holes on the exterior airfoil surface.

In a further embodiment of any of the above, the first cooling hole is arranged radially inward from a cooling hole closest to an airfoil tip.

In a further embodiment of any of the above, the determining step includes calculating a reference point within the measured cooling hole based upon a perimeter of the cooling hole.

In a further embodiment of any of the above, the first and second cooling holes are provided on a pressure side of the airfoil.

In a further embodiment of any of the above, the method includes the step of clamping the airfoil in a fixture. The measuring step is performed with the airfoil in the fixture.

In a further embodiment of any of the above, the measuring step is performed by optically measuring the first and second cooling holes.

In a further embodiment of any of the above, the outputting step includes displaying a message as to whether the part is within desired specifications that correspond to the reference information.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2A is a perspective view of the airfoil having the disclosed cooling passage.

FIG. 2B is a plan view of the airfoil illustrating directional references.

FIG. 3 is a schematic view of a blade and an associated measurement system for inspecting creep and/or untwist of the airfoil.

FIG. 4 is an enlarged view of an example cooling hole in an exterior airfoil surface of the airfoil.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

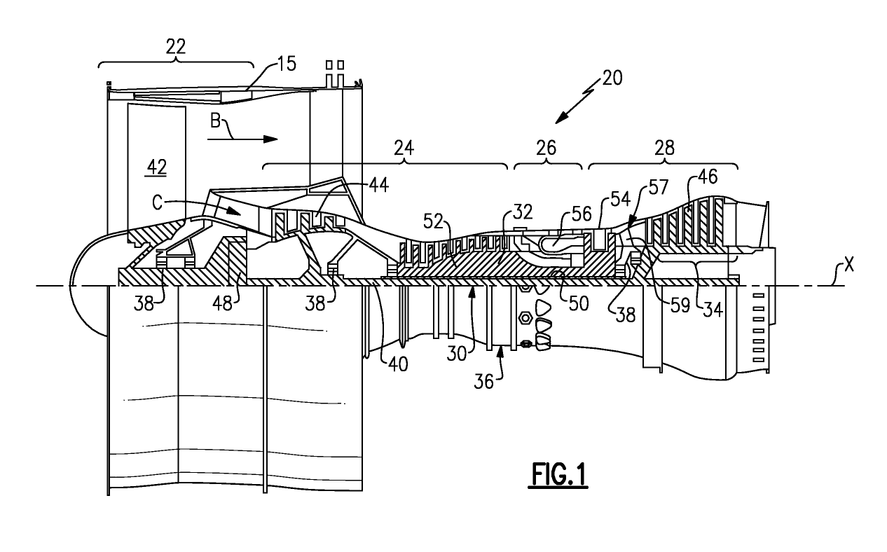

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmenter section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis X which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7 ° R)]^{0.5}. The “Low corrected fan tip speed” as disclosed herein according to one non-limiting embodiment is less than about 1150 ft/second (350.5 meters/second).

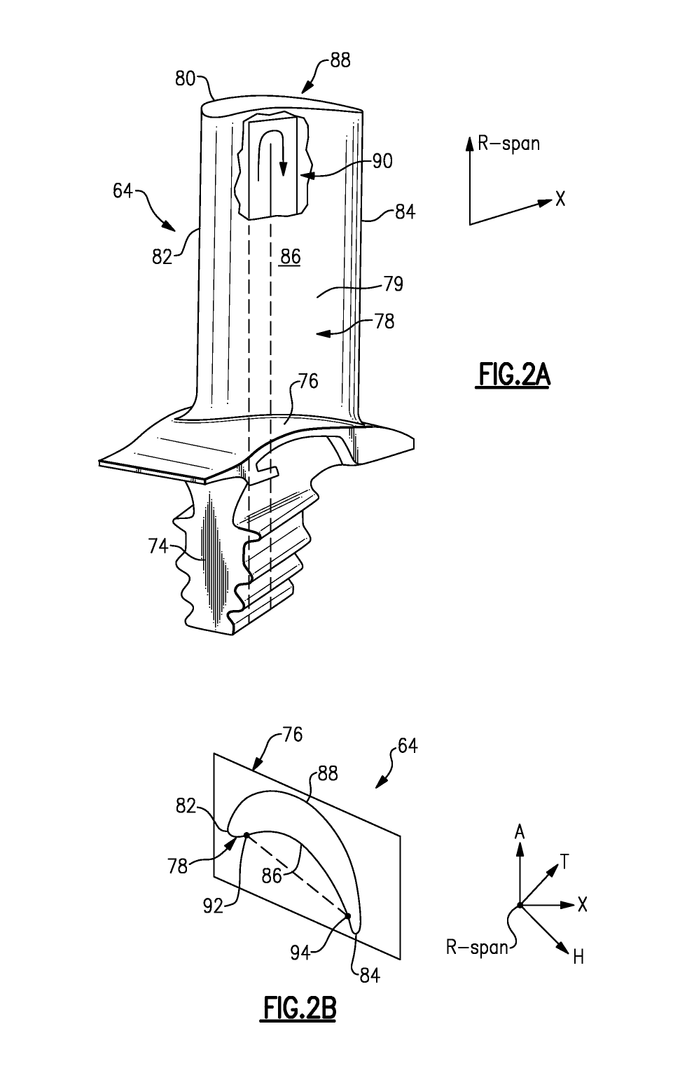

Referring to FIGS. 2A and 2B, a root 74 of each turbine blade 64 is mounted to the rotor disk. The turbine blade 64 includes a platform 76, which provides the inner flow path, supported by the root 74. An airfoil 78 extends in a radial direction R from the platform 76 to a tip 80. It should be understood that the turbine blades may be integrally formed with the rotor such that the roots are eliminated. In such a configuration, the platform is provided by the outer diameter of the rotor. The airfoil 78 provides leading and trailing edges 82, 84. The tip 80 is arranged adjacent to a blade outer air seal (not shown).

The airfoil 78 of FIG. 2B somewhat schematically illustrates exterior airfoil surface 79 extending in a chord-wise direction H from a leading edge 82 to a trailing edge 84. The airfoil 78 is provided between pressure (typically concave) and suction (typically convex) wall 86, 88 in an airfoil thickness direction T, which is generally perpendicular to the chord-wise direction H. Multiple turbine blades 64 are arranged circumferentially in a circumferential direction A. The airfoil 78 extends from the platform 76 in the radial direction R, or spanwise, to the tip 80.

The airfoil 78 includes a cooling passage 90 provided between the pressure and suction walls 86, 88. The exterior airfoil surface 79 may include multiple film cooling holes (see FIG. 3) in fluid communication with the cooling passage 90.

An example airfoil cooling hole configuration is shown in FIG. 3. It should be understood that a different cooling hole configuration may be used with the disclosed method, if desired. Numerous cooling holes are provided on the exterior airfoil surface 79. One or more of these cooling holes may be used to determine the growth of the part resulting from use in the engine during an overhaul procedure. In one example, the cooling holes provide first, second and third cooling holes 92, 94, 96 used as reference features. In the example, the first reference feature is a cooling hole 92 near the leading edge 82, and the second and third reference features 94 are cooling holes 94, 96 near the trailing edge 84. In the example, the reference features are cooling holes rather than specialized reference holes or dimples that are created for the sole purpose of measurement. In this manner, unnecessary machining and potentially wasteful cooling fluid leakage are avoided.

During an inspection procedure, the blade 64 may be mounted in a fixture 100, which provides a reference surface 102 that can be used in subsequent measurements. A measurement system 104 is used to measure positions of various reference features to determine creep and untwist. In this application, “creep” corresponds to growth of the part in the radial direction R, and “untwist” corresponds to flattening of the curvature of the airfoil 78 in a chord-wise direction H.

The measurement system 104 includes a sensor 108 in communication with a computing device 106. In one example, the sensor 108 is an optical sensor, although other sensors may be used. Other input devices 110 may also communicate with the computing device 106 to provide information relating to the blade 64.

A memory 112 includes reference information 114 relating to the part within the fixture 100. The reference information 114 may include the original measurements relating to the reference features when the part was new as well as information relating to the limits of these measurements, which correspond to the dimensions at which the part should be discarded.

Output devices 118, such as monitor 116, are in communication with the computing device 106.

In one example, a method of measuring untwist includes measuring the first and second cooling holes 92, 94. Untwist is determined in a chord-wise direction H based upon the measurement. In one example, the untwist is determined by calculating a line between the first and second cooling holes 92, 94, as illustrated by the dashed line in FIG. 2B.

The untwist determination is evaluated relative to reference information, such as the original part dimensions and part limits. A part status is outputted, such as displaying the information on the monitor 116, based upon the evaluation. In this manner, the remaining usefulness of the part is communicated to the operator inspecting the blade during the overhaul procedure. The operator can then determine if the blade can be reinstalled in the engine for continued use, or whether a new replacement blade should be used.

The position of the reference features may be determined by calculating a focal distance of the reference feature from the sensor 108. The reference information may include a reference focal distance of the part when new. The fixture 100 may include a reference surface 102 from which the reference focal distance and untwist focal distance relate.

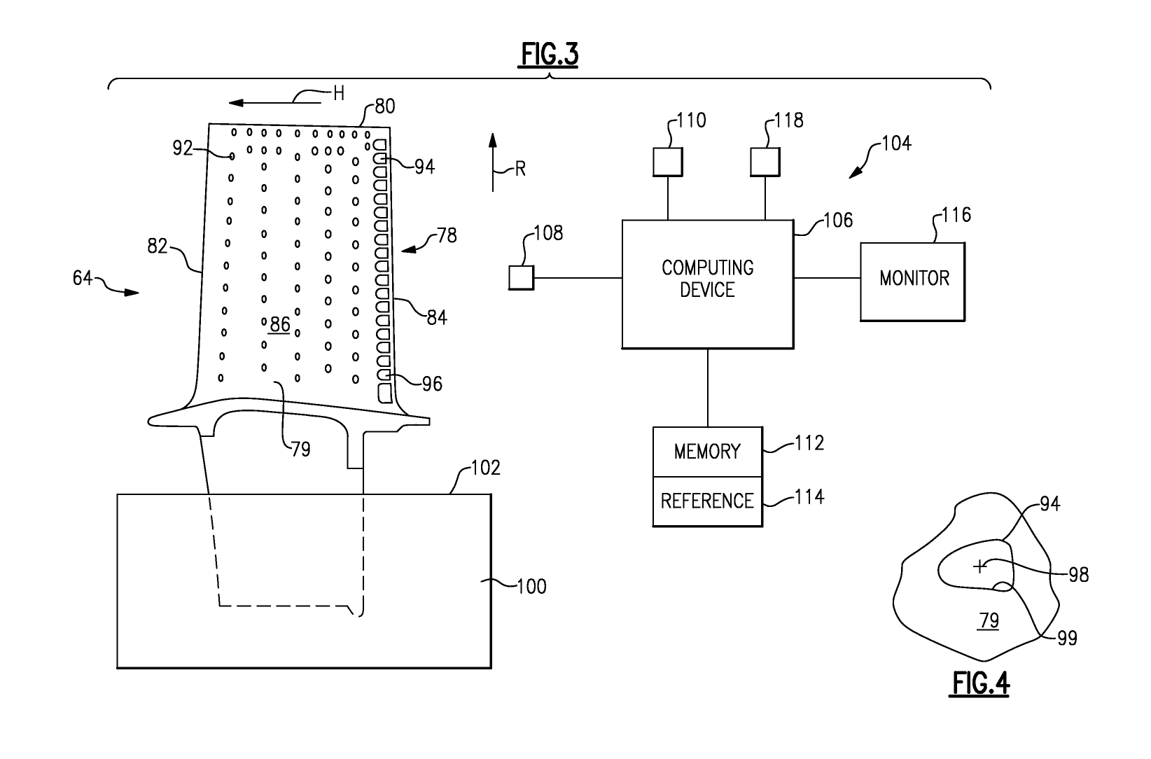

The location of the reference features may be provided by determining a reference point 98. In the example shown in FIG. 4, the reference point 98 may correspond to a position within a perimeter 99 of the second cooling hole 94.

In another example, a method of measuring creep includes measuring the cooling holes 94, 96 near the trailing edge 84. Creep in the radial direction R is determined based upon the measurement. In the example, the cooling holes 94, 96 are arranged in a row that is aft-most on the exterior airfoil surface 79. In the example, the cooling hole 94 is arranged radially inward from a cooling hole in the row that closest to the airfoil tip. Typically, the cooling holes closest to the tip 80 may become distorted or irregular compared to their original shape due to the high thermal temperatures experienced by the airfoil 78 during engine operation.

It should be noted that the computing device can be used to implement various functionality disclosed in this application. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of measuring untwist in an gas turbine engine airfoil, the method comprising:
measuring first and second cooling holes on an exterior airfoil surface of an airfoil;
determining untwist in a chord-wise direction of the airfoil based upon the measurement;
evaluating the determination relative to reference information for the airfoil; and
outputting a part status based upon the evaluation.

2. The method according to claim 1, wherein the first cooling hole is near a leading edge of the airfoil, and a second cooling hole is near a trailing edge of the airfoil.

3. The method according to claim 1, wherein the first and second cooling holes are provided on a pressure side of the airfoil.

4. The method according to claim 1, comprising the step of clamping the airfoil in a fixture, and the measuring step is performed with the airfoil in the fixture.

5. The method according to claim 1, wherein the measuring step is performed by optically measuring the first and second cooling holes.

6. The method according to claim 5, wherein the measuring step includes determining a untwist focal distance to the first and second cooling holes, and the reference information includes a reference focal distance of a new part.

7. The method according to claim 1, wherein the determining step includes calculating a line in the chord-wised direction between the first and second cooling holes.

8. The method according to claim 1, wherein the outputting step includes displaying a message as to whether the part is within desired specifications that correspond to the reference information.

9. The method according to claim 1, wherein the determining step includes calculating a reference point within the measured cooling hole based upon a perimeter of the cooling hole.

10. A method of measuring creep in an gas turbine engine airfoil, the method comprising:
measuring first and second cooling holes near a trailing edge of an exterior airfoil surface;
determining creep based upon the measurement;
evaluating the determination relative to reference information for the airfoil; and
outputting a part status based upon the evaluation.

11. The method according to claim 10, wherein the determining step includes determining creep in a radial direction of the airfoil.

12. The method according to claim 10, wherein the first and second cooling holes are arranged in a row.

13. The method according to claim 12, wherein the row is an aft-most row of cooling holes on the exterior airfoil surface.

14. The method according to claim 12, wherein the first cooling hole is arranged radially inward from a cooling hole closest to an airfoil tip.

15. The method according to claim 10, wherein the determining step includes calculating a reference point within the measured cooling hole based upon a perimeter of the cooling hole.

16. The method according to claim 10, wherein the first and second cooling holes are provided on a pressure side of the airfoil.

17. The method according to claim 10, comprising the step of clamping the airfoil in a fixture, and the measuring step is performed with the airfoil in the fixture.

18. The method according to claim 10, wherein the measuring step is performed by optically measuring the first and second cooling holes.

19. The method according to claim 10, wherein the outputting step includes displaying a message as to whether the part is within desired specifications that correspond to the reference information.
